(19) United States
(12) Patent Application Publication
(10) Pub. No.: US 2024/0297950 A1
(43) Pub. Date: Sep. 5, 2024

(54) METHOD FOR COLOR CORRECTING A DIGITAL PRINTER

(71) Applicant: AKZENTA PANEELE + PROFILE GMBH, Kaisersesch (DE)

(72) Inventors: Markus KLEMM, Bielefeld (DE); Timo LINNENBRÜGGER, Cochem (DE); Hans-Jürgen HANNIG, Bergisch Gladbach (DE)

(21) Appl. No.: 18/573,174

(22) PCT Filed: Jun. 29, 2022
(86) PCT No.: PCT/EP2022/067899

§ 371 Date: Dec. 21, 2023

(30) Foreign Application Priority Data
Jun. 30, 2021 (EP) 21182847.0

(51) Int. Cl. H04N 1/60; B41J 2/21; G01J 3/46; H04N 1/50

(52) U.S. Cl. CPC H04N 1/6041; B41J 2/2121; B41J 2/2135; G01J 3/462; H04N 1/502; H04N 1/6008; H04N 1/6044

(57) ABSTRACT

The disclosure relates to a method for color correcting a digital printer over a printing width of the digital printer, having the steps of: a) providing a specified digital image, said digital image having at least one color channel pattern, wherein each color channel pattern is assigned to a print color channel of the digital printer; b) determining at least one test color of the specified digital image; c) generating a digital test pattern, said digital test pattern being provided with at least one single-colored test strip which is designed to be printed over the printing width of the digital printer, d) printing the digital test pattern using the digital printer; e) detecting the color values of the printed test pattern on the basis of the position thereof in the direction of the printing width using an optical color measuring device; f) generating correction data for the digital printer using the detected color values; and g) using the correction data on the digital printer and/or the specified digital image. The method is suitable in particular for color correcting substantially single-colored prints and for reducing the formation of stripes in the printing direction.

### CROSS-REFERENCE TO RELATED APPLICATIONS

This application is a U.S. National Phase Application under 35 U.S.C. 371 of International Application No. PCT/EP2022/067899, filed on Jun. 29, 2022, which claims the benefit of European Patent Application No. 21182847.0, filed on Jun. 30, 2021. The entire disclosure of the aforementioned European Patent Application is incorporated herein by reference.

### FIELD

The present disclosure relates to a method for color correcting a digital printer, a device for carrying out the method and a use of the method.

### BACKGROUND

This section provides background information related to the present disclosure which is not necessarily prior art.

Methods for color correcting digital printers are known per se. In this case, deviations from the expected print result are determined and taken into account during printing in such a way that the print corresponds more closely to the expected print result.

A major problem with the output of digital images are the color and density deviations caused by printing artifacts over the printing width of a printer, which are often visible as stripes in the direction of printing, especially with the same color (“single color”). The reasons for this are manifold, e.g. the print dot size (drop size with inkjet) is never exactly the same over the entire width of a print head and from print head to print head. Furthermore, the positional accuracy of each print dot is subject to different tolerances and therefore changes the tonal value originally desired by ripping. Furthermore, especially in inkjet printing, spray mist deposited on the substrate can change the desired color and density values. Particularly in inkjet printing, a different flow behavior, especially on non-absorbent materials, can change the print density unfavorably due to different positions of print heads in the running direction and their distance to pinning or final drying. Furthermore, especially in inkjet printing, misprints (nozzle errors) can have a negative visual impact on the print result.

In order to determine the position and strength of these printing artifacts, it is known to print and analyze test patterns. The information derived therefrom can then be used to make corrections in a variety of ways.

However, one problem with this type of correction data determination is that the results that can be obtained therefrom are often insufficient. In particular, the homogeneity achieved by the correction in the individual colors is sometimes not equally achieved in the combined print. This poses a major problem, especially when printing essentially single-colored images, because remaining deviations are particularly noticeable and lead to clearly visible stripes in the direction of printing.

Methods for color correcting digital printers can therefore still offer potential for improvement. In particular, there may be potential for improvement in the color correction of essentially single-colored prints and in the reduction of the formation of stripes in the printing direction.

### SUMMARY

This section provides a general summary of the disclosure, and is not a comprehensive disclosure of its full scope or all of its features.

It is therefore the object of the present disclosure to provide an improved method for color correcting digital printers.

The disclosure proposes a method for color correcting a digital printer over a printing width of the digital printer, wherein the digital printer is provided for outputting a specified digital image, wherein the method comprises the steps of:
a) providing the specified digital image, wherein the digital image comprises at least one color channel pattern, wherein each color channel pattern is associated to a print color channel of the digital printer;
b) determining at least one test color of the specified digital image;
c) creating a digital test pattern, wherein the digital test pattern is provided with at least one single-colored test stripe intended to be printed over the printing width of the digital printer, wherein each single-colored test stripe is defined by a print density of at least one print channel of the digital printer according to the following steps:
   i) determining a print density of at least one print color channel of the digital printer intended for printing the test color, and
   ii) determining the print density determined in step i) as the print density of the single-colored test stripe;
d) printing the digital test pattern by use of the digital printer;
e) detecting the color values of the printed test pattern as a function of their position in the direction of the printing width by use of an optical color measuring device;
f) creating correction data for the digital printer based on the detected color values; and
g) applying the correction data to the digital printer and/or the specified digital image.

In the sense of the present disclosure, a digital printer is understood in particular to mean a device which can output colored print dots on a substrate which form the corresponding image.

In the sense of the present disclosure, a digital image is understood to mean in particular a digitally storable image whose image information is determined via pixels, each of which has a color value with respect to a color system. In the sense of the present disclosure, a specified digital image is a digital image that is intended for printing.

In step a) of the method, thus, the specified digital image is provided, wherein the digital image comprises at least one color channel pattern, wherein each color channel pattern is associated to a print color channel of the digital printer.

In the sense of the present disclosure, a color channel pattern is understood in particular to mean a part of the digital image which has only the information for one color channel of the color system in which the digital image is stored. For example, the digital image can be defined by color values in the CMYK color system and a color channel pattern has, for example, only the color values of the C color channel.

In the sense of the present disclosure, a print color channel is understood in particular to mean a color channel in which the printer can print. For example, the printer may be provided for printing in the CMYK color system and a print color channel may be the C color channel.

In other words, it is particularly intended that the digital image is composed of such color channel patterns that correspond to the print color channels of the digital printer. For example, it may be provided that the digital image in the CMYK color system is determined by the color channel patterns of the C color channel and the M color channel and the printer is a printer that can print in the CMYK color system. Thus, the color channel patterns C and M of the digital image are respectively associated to the print color channel C and M.

In step b) of the method, at least one test color of the specified digital image is determined.

In the sense of the present disclosure, a test color of the specified digital image means a color of the specified digital image or a color that is similar to such a color that is used for the method according to the disclosure. In particular, a test color of the specified digital image in the sense of the present disclosure is to be understood to mean a color value which occurs in the digital image or is similar to a color value of the specified digital image. A similar color or a similar color value is to be understood in the sense of the present disclosure to mean a color or a color value which does not exceed a certain delta E value with respect to the color or the color value to which it is to be similar, i.e. does not exceed a certain color distance.

Preferably, it can be provided that the test color determined in step b) is a primary color of the specified digital image.

In the sense of the present disclosure, a primary color of the specified digital image is to be understood in particular to mean a color value which has a significant proportion of the digital image.

Further in step c), a digital test pattern is created, wherein the digital test pattern is provided with at least one single-colored test stripe which is intended to be printed over the printing width of the digital printer, wherein each single-colored test stripe is defined by a print density of at least one print color channel of the digital printer according to the following steps:
i) determining a print density of at least one print channel of the digital printer intended for printing the test color, and
ii) determining the print density determined in step i) as the print density of the single-colored test stripe.

In the sense of the present disclosure, a digital test pattern is to be understood to mean a digital image.

In the sense of the present disclosure, a single-colored test stripe is to be understood to mean in particular an area of the digital test pattern which has a single color value and extends transversely to the printing direction of the digital printer.

In the Sense of the present disclosure, the fact that each single-colored test stripe is determined by a print density of at least one print color channel of the digital printer means in particular that the single-colored test stripe has a color value which, like the specified digital image, is defined by the color channels which correspond to the print color channels of the digital printer. Accordingly, the test stripe can be defined by at least one color channel that corresponds to a print color channel of the digital printer and at most by all color channels that correspond to the print color channels of the digital printer.

In the sense of the present disclosure, a print density is to be understood to mean the combination of a print dot density and print dot size. In the sense of the present disclosure, the print density can accordingly be perceptible as color saturation.

In the sense of the present disclosure, the print density can also correspond to a color value in a printed image and can accordingly be measured analogously. For example, the print density can be measured by use of a spectrophotometer. Alternatively, the print density can be measured by use of a scanner, for example an RGB scanner. In this case it can preferably be provided that the print density can be determined by the value of a measured complementary color. Thus, advantages result from the combination of RGB scanner and CMYK printer and the single-colored test stripes created according to the disclosure.

Thus. in particular, the print density intended for printing the test color is determined, wherein the print density of at least one print color channel of the digital printer is determined. This print density is then determined as the print density of the single-colored test stripe.

It is therefore provided, for example, that the test color is defined via three color channels for example via CMY color channels, wherein the printer comprises the CMYK print color channels, and the print density of the C color channel of the test color is determined in step i) and is specified as the print density of the single-colored test stripe in step ii). Alternatively, for example, the print density of the C and M color channels of the test color can be determined and specified as the print density of the single-colored test stripe.

In step d), the digital test pattern is then printed by use of the digital printer.

In step e), the color values of the printed test pattern are determined as a function of their position in the direction of the printing width by use of an optical color measuring device.

In the sense of the present disclosure, this means in particular that the optical color measuring device is used to detect the color of the printed test pattern over the printing width and each respective position over the printing width is associated with a color value measured at this position.

In step f), correction data for the digital printer are created by use of the detected color values.

In step g), the correction data are applied to the digital printer and/or the specified digital image.

In particular, this means that correction data are created by determining deviations between the color values determined by means of the optical color measuring device and the expected color values of the digital test pattern as a function of their position in the direction of the printing width, and by applying the correction data the specified digital image and/or the digital printer are changed accordingly in order to counteract the determined deviations.

The method described above makes it possible to reduce printing artifacts for the specified digital image particularly well, in particular the formation of stripes in the printing direction for digital images with a high proportion of single colors. In particular, this allows large-area decorations, such as stone decorations, to be printed particularly precisely. Compared to known methods for color correction of a digital printer, the method described above can also be used in particular to reduce the formation of stripes caused by deviations in the print dot size (droplet size in inkjet) over the width of a print head and between print heads. Furthermore, the method described above can be used to reduce artefacts that occur in particular in inkjet printing due to spray mist deposited on the substrate or due to different flow behaviour, especially on non-absorbent materials, due to different positions of print heads in the running direction and their distance to pinning or final drying.

Preferably, it can be provided that the digital test pattern can be printed by use of the digital printer in step d) on a print substrate that is the same print substrate on which also the specified digital image is to be printed.

In this way it can be achieved that effects in particular caused by the substrate can be corrected by the color correction.

Preferably, it can be provided that at least one single-colored test stripe is defined by the print density of all print color channels of the digital printer, wherein in step i) the print density of all print color channels of the digital printer intended for printing the test color is determined; and/or
at least one single-colored test stripe is defined by the print density of a single print color channel of the digital printer, wherein in step i) the print density intended for printing the test color is determined from a single print color channel of the digital printer; and/or
at least one single-colored test stripe is defined by the print density of more than one and less than all print color channels of the digital printer, wherein in step i) the print density intended for printing the test color is determined from more than one and less than all print color channels of the digital printer.

Thus, in a preferred embodiment, it may be provided that at least one single-colored test stripe is defined by the print density of all print color channels of the digital printer, wherein in step i) the print density of all print color channels of the digital printer intended for printing the test color is determined.

In particular, this is understood to mean that the single-colored test stripe has the same color value as the test color.

Thus, it can advantageously be achieved that the color correction can be carried out in the combined print of all colors used for the test color over the printing width. In particular, this can reduce artifacts that occur in inkjet printing due to spray mist deposited on the substrate or due to different flow behavior, especially on non-absorbent materials, due to different positions of print heads in the running direction and their distance to pinning or final drying.

Alternatively or additionally, in a preferred embodiment, it may be provided that at least one single-colored test stripe is defined by the print density of a single print color channel of the digital printer, wherein in step i) the print density of a single print color channel of the digital printer intended for printing the test color is determined.

Thus, it can advantageously be achieved that in particular artifacts can be reduced, which are caused by deviations in the print dot size (drop size with inkjet) over the width of a print head and between print heads. In particular, in this way it can be achieved that artifacts that are attributable to a single print color channel can be reliably identified and corrected.

Further alternatively or additionally, in a preferred embodiment, it may be provided that at least one single-colored test stripe is defined by the print density of more than one and less than all print color channels of the digital printer, wherein in step i) the print density of more than one and less than all print color channels of the digital printer intended for printing the test color is determined.

Thus, it can advantageously be achieved that artifacts resulting from the combined printing of less than all print color channels can be reliably identified and corrected.

In a preferred embodiment, it can be provided that the digital test pattern has at least one of the aforementioned single-colored test stripes. In this way, it can advantageously be achieved that the correction is particularly successful. Without being bound by any theory, it is assumed that by combining these test stripes it can be achieved that the source of the print artifacts can be identified particular certain, so that a color correction can be achieved which leads to particularly good and stable results.

Preferably, it can be provided that more than one test color is determined in step b) and the digital test pattern can be provided with at least one single-colored test stripe for each specific test color.

Thus, it can be achieved that the formation of stripes even in areas of different color values can be reduced in the case of multicolored specified digital images.

Preferably, it can be provided that the digital test pattern for at least one test color of the specified digital image is provided with at least two single-colored test stripes and preferably the number of single-colored test stripes for the at least one test color of the specified digital image is less than or equal to the number of color channels of the digital printer,
wherein preferably for the at least one test color a single-colored test stripe is printed by the print density of a single print color channel of the digital printer, a single-colored test stripe is defined by the print density of all print color channels of the digital printer, and the optionally remaining single-colored test stripes are defined by the print density of more than one and less than all print color channels of the digital printer.

Thus, it can be achieved that the number of test stripes can be kept low, which results in a simpler calculation of the correction data and at the same time a sufficient number of color combinations can be covered in order to achieve very good results for color correction over the printing width.

Preferably, it can be provided that the color channels of the digital printer have a printing sequence, whereby the single-colored test stripe, which is defined by the print density of a single print color channel of the digital printer, is defined by the print density of the print color channel to be printed first according to the printing sequence.

Thus, it can be achieved that the color correction starts with the color to be printed first, which in particular simplifies a further correction without being bound to any theory, since superimposition of different effects is avoided when applying the correction.

Preferably, it may be provided that the single-colored test stripes defined by the print density of more than one and less than all of the print color channels of the digital printer are selected such that
a first of these single-colored test stripes is defined by the print density of the print color channel to be printed first according to the printing sequence and additionally by the print density of the print color channel to be printed subsequently according to the printing sequence,
and optionally each further one of these single-colored test stripes is defined by the print density of the respective previous single-colored test stripe and additionally by the print density of the print color channel to be printed subsequently according to the printing sequence.

Thus, it can be achieved that print color channels in the test stripes are combined in such a way that respectively only one print color channel is added from a first to a second test stripe, so that the color correction can be calculated particularly easily and reliably.

For example, it can particularly preferably be provided that four print color channels are provided for printing a test color, for example CMYK, wherein the print color channels are printed in the order C, M, Y and K. The digital test pattern can then particularly preferably have four single-colored test stripes, wherein the first single-colored test stripe is defined by the print density of the C print color channel provided for printing the test color, the second single-colored test stripe is defined by the print density of the C and M print color channels provided for printing the test color, the third single-colored test stripe is defined by the print density of the C, M and Y print color channels provided for printing the test color, and the fourth single-colored test stripe is defined by the print density of all CMYK print color channels provided for printing the test color. In particular, it may be provided, for example, that several test colors of the specified digital image are determined and the previously described single-colored test stripes are respectively determined for each test color.

Thus, it can be achieved that by use of a particularly small number of test stripes both artifacts caused by individual print head rows and artifacts caused by combined printing of several colors can be compensated for by the color correction. In particular, in this way it can be achieved that the color correction takes these artifacts into account reliably and accurately without having to use complicated calculation methods to separately calculate the effects.

Preferably, it can be provided that the test colors are selected from the colors occurring most frequently in the specified digital image, wherein optionally a minimum distance is maintained in the color space between several test colors, and/or the test colors are selected independently of a color frequency in the specified digital image and a largest possible distance between the test colors in the color space is maintained.

Thus, it can be achieved that a reliable color correction is obtained with just a few test colors. Minimum distances in the color space can be obtained, for example, by use of delta E values or by means of a histogram.

Preferably, it can be provided that steps d) to g) are carried out iteratively several times in succession.

This allows the color correction to achieve a particularly homogeneous print result. It is understood that in the case of an iterative procedure, wherein in step g) it is provided that the correction data are applied to the specified digital image, the correction data are applied accordingly to the digital test pattern.

It may particularly preferably be provided that steps d) to g) are carried out iteratively until the result of the correction is good enough. In particular, steps d) to g) can be carried out until the color values detected in step e) are sufficiently homogeneous over the printing width or the correction values determined in step f) are sufficiently small.

Optionally, the success of the method can be checked, wherein the specified digital image is printed with the correction data applied accordingly.

Preferably, it can be provided that the optical color measuring device is selected from the group consisting of a color sensor, a colorimeter, a spectrophotometer, a digital camera or a spectrodensitometer, wherein the optical color measuring device is preferably based on the same color model as the digital printer.

In a preferred embodiment, it may be provided that the color measuring device only measures relative color deviations over the printing width and/or the correction data for the digital printer only takes into account relative color deviations over the printing width.

In other words, it can be provided that the color correction does not measure the deviation of the printed single-colored test stripes from the expected color, but only color variations of the printed single-colored test stripes over the printing width. This allows the color correction to compensate for printing artifacts particularly efficiently without being limited by the color fidelity of the print itself.

Preferably, it can be provided, that step e) is optionally carried out several times in succession with different settings of the optical color measuring device, in particular under different lighting conditions and/or exposure times.

Thus. it can be achieved that even extremely low fluctuations in the color of the printed test stripes can be detected.

In a preferred embodiment, it can be provided that the test image comprises positioning aids. In this way it can be achieved that the detection of the color values in step e) can be particularly precisely correlated with the printing width, which makes the color correction particularly accurate to be applied.

It may be provided that the test stripes have different thicknesses in the printing direction, wherein the thicknesses can be conveniently selected so that the test stripes can be easily detected by the optical color measuring device used. Moreover, it can be provided, that the test stripes extend over the entire printing width of the digital printer. In particular, this allows a color correction over the entire printing width. Alternatively, the test stripes can also be provided only for sections of the printing width, for example for sections over the width of the optical color measuring device or the width of individual print heads. This allows the method to be adapted to the specific conditions of the printer and the color measuring device.

Preferably, it can be provided that in step g) the correction data are applied to the printer, wherein in particular the correction is made by adjusting the print head electronics.

Preferably, it can be provided that in step g) the correction data are applied to the specified digital image, wherein the correction is made in particular by adjusting print dots of the color channel patterns of the specified digital image.

By applying the correction data to the specified digital image, it can advantageously be achieved that the optimum operating point of the print heads does not have to be changed. In this way it can be achieved that the application of the correction data does not cause any other disadvantages in the printing process. By implementing the correction by adjusting the respective color channel patterns, it can advantageously be achieved that, compared to applying the correction data to the specified digital image as such, no correction artifacts occur between color channels. This means that a color correction with particular color fidelity can be achieved. In addition, by adjusting the print dots, it can in particular be achieved that the correction is equally good for areas with low and high correction, thereby achieving a particularly homogeneous correction.

Preferably, it can be provided that when applying the correction data to the specified digital image, correction data can be applied to the individual color channel patterns of the specified digital image, wherein in particular correction data are only applied if the respective raster process provides for a print dot at the respective image position of the color channel pattern. Thus, if the color channel pattern for a color print channel does not provide a print dot at a point, no correction of this color channel is therefore applied to this point. It may preferably be provided that the correction is made by adjusting the print dots of the color channel patterns of the specified digital image when the print dots are created or after the print dots have been created.

Preferably, it may be provided that the color model of the intended digital image is selected from RGB, CMY and CMYK, wherein the color model is in particular CMYK.

The disclosure further proposes a device comprising a data memory, a computing unit, a digital printer for outputting a specified digital image and an optical color measuring device, wherein the device is adapted to carry out the method described above.

The disclosure also proposes a use of the method or device described above, wherein the method or device is used for color correction for printing decorations, in particular for printing decorations with a small variety of colors, for example for wood and/or stone decorations.

Surprisingly, it could be shown that the method described above is particularly suitable for color correction in such applications. In particular, stripes can be recognized particularly well in such decorations, so that a particularly good color correction is required for high-quality prints.

Further advantages and advantageous embodiments of the method according to the disclosure, the device according to the disclosure and the use according to the disclosure are illustrated by the figures and explained in the following description. It should be noted that the figures are for descriptive purposes only and are not intended to limit the disclosure in any way.

### DRAWINGS

The drawings described herein is for illustrative purposes only of selected embodiment(s) and not all possible implementations, and are not intended to limit the scope of the present disclosure.

In the Figures:

FIG. 1 schematically shows the flow of the method according to a preferred embodiment of the disclosure; and

FIG. 2 schematically shows a test pattern created or printed out as a digital test pattern in one embodiment of the method according to the disclosure.

Corresponding reference numerals indicate corresponding parts throughout the view of the drawings.

### DETAILED DESCRIPTION

Example embodiment(s) will now be described more fully with reference to the accompanying drawings.

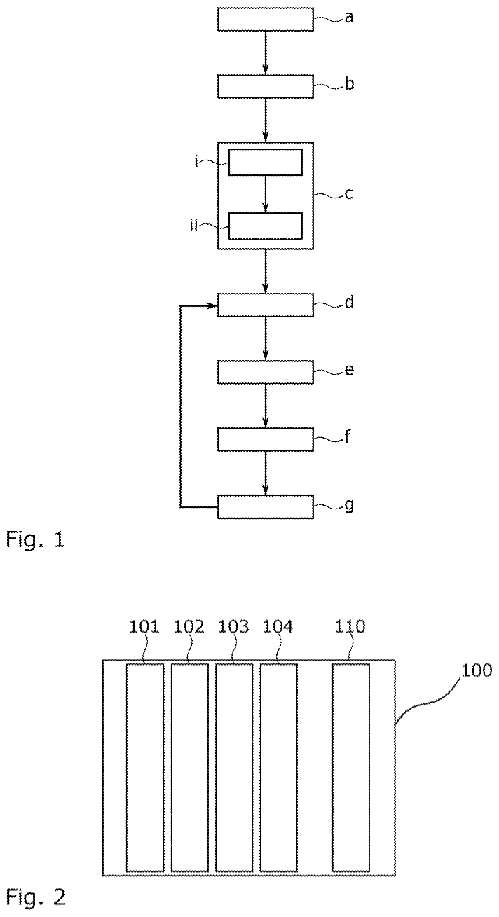

FIG. 1 schematically shows the flow of the method according to a preferred embodiment of the disclosure. In step a), first a specified digital image is provided, which is intended to be printed on a digital printer. For example, the digital printer is an inkjet printer with the four print color channels CMYK, which are printed in the sequence Y, M, C and K. The specified digital image is a stone decoration, for example, which is intended to be printed on a decorative panel. The digital image is accordingly composed of four color channel patterns, which are assigned to the four printing color channels CMYK of the digital printer.

In step b), at least one test color of the specified digital image is determined. For example, two test colors are determined by plotting the color values occurring in the digital image in a histogram according to frequency. The two most frequent colors are determined as test colors, wherein care is taken to ensure that the colors have a certain minimum distance in the color space. For example, one test color consists of 5% cyan, 7% magenta, 4% yellow and 16% black and a second test color consists of 8% cyan, 3% magenta, 5% yellow and 12% black.

In step c), a digital test pattern 100 is now created, wherein an exemplary test pattern is shown schematically in FIG. 2. For this purpose, the digital test pattern 100 is provided with at least one single-colored test stripe 101, 102, 103, 104, 110. For example, the test pattern 100 for the first test color is provided with a total of four single-colored test stripes 101, 102, 103, 104, i.e. with as many test stripes as there are print color channels. For the first test color, for example, the print density intended for printing the test color is determined in step i) for the first single-colored test stripe 101 from a print color channel of the digital printer. For example, the print color channel to be printed first according to the printing sequence is used. According to the present example, the print density of the Y print color channel of the first test color, i.e. 4% yellow, is determined and in step ii) is specified as the print density of the first single-colored test stripe 101. For the second single-colored test stripe of the first test color 102, the print density of the print color channels to be printed first and second according to the printing sequence is determined in step i), for example, and specified in step ii) as the print density of the single-colored test stripe. In other words, according to the present example, the print density of the Y print color channel and the M print color channel of the first test color, i.e. 4% yellow and 7% magenta, is thus specified as the print density of the second single-colored test stripe 102. For the third single-colored test stripe of the first test color 103, for example, the print density intended for the test color to be printed first, second and third in the printing sequence is determined in step i) and is specified in step ii) as the print density of the single-colored test stripe. In other words, according to the present example, the print density of the Y print color channel, the M print color channel and the C print color channel of the first test color, i.e. 4% yellow, 7% magenta and 5% cyan, is specified as the print density of the third single-colored test stripe 103. For the fourth single-colored test stripe of the first test color 104, the print density of all print color channels intended for printing the test color is determined in step i), for example, and is specified in step ii) as the print density of the fourth single-colored test stripe. In other words, according to the present example, the print density of the test color comprising 5% cyan, 7% magenta, 4% yellow and 16% black is specified as the print density of the fourth single-colored test stripe 104.

Furthermore, in step c), the digital test pattern 100 can also be provided with single-colored test stripes for further test colors. For example, the digital test pattern 100 may comprise a fifth single-colored test stripe 110, wherein for the fifth single-colored test stripe 110 in step i), for example, the print density of all print color channels intended for printing the second test color is determined and is specified in step ii) as the print density of the fifth single-colored test stripe 110. In other words, according to the present example, the print density of the fifth test stripe 110 is specified as 8% cyan, 3% magenta, 5% yellow and 12% black.

In step d), the digital test pattern 100 is now printed by use of the digital printer. The digital test pattern 100 is printed, for example, on a panel of the type that will later be used to print the decor.

In step e), the color values of the printed test pattern 100 are detected by use of an optical color measuring device as a function of their position in the direction of the printing width. For example, the printed test pattern 100 is scanned by the color measuring device and fluctuations in the color of the single-colored test stripes along the printing width are determined.

In step f), correction data are now created for the digital printer based on the color values and then applied to the digital printer and/or the specified digital image in step g). For example, correction data are created which stipulate that a higher printing density of a certain print color channel must be provided at certain points along the printing width for certain print colors. This data can then be applied, for example, by adjusting the print heads along the printing width or by changing the specified digital image.

After an optional iterative application of method steps d) to g), the correction data are applied to the digital printer and/or the specified digital image and the specified digital image can be printed with the color correction. As a result, the print then exhibits reduced formation of stripes in the direction of printing, in particular in the case of single-colored decorations such as stone decorations.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for color correcting a digital printer over a printing width of the digital printer, wherein the digital printer is provided for outputting a specified digital image, wherein the method comprises the steps of:
a) providing the specified digital image, wherein the digital image comprises at least one color channel pattern, wherein each color channel pattern is associated with a print color channel of the digital printer;
b) determining at least one test color of the specified digital image;
c) creating a digital test pattern, wherein the digital test pattern is provided with at least one single-colored test stripe intended to be printed over the printing width of the digital printer, wherein each single-colored test stripe is defined by a print density of at least one print color channel of the digital printer according to the following steps:
i) determining a print density of at least one print color channel of the digital printer intended for printing the test color; and
ii) specifying the print density determined in step i) as the print density of the single-colored test stripe;
d) printing the digital test pattern by use of the digital printer;
e) detecting the color values of the printed test image as a function of their position in the direction of the printing width by use of an optical color measuring device;
f) creating correction data for the digital printer based on the detected color values; and
g) applying the correction data to the digital printer and/or the specified digital image.

2. The method according to claim 1, wherein at least one single-colored test stripe is defined by the print density of all print color channels of the digital printer, wherein in step i) the print density of all print color channels of the digital printer intended for printing the test color is determined, and/or
at least one single-colored test stripe is defined by the print density of a single print color channel of the digital printer, wherein in step i) the print density intended for printing the test color is determined from a single print color channel of the digital printer, and/or
at least one single-colored test stripe is defined by the print density of more than one and less than all print color channels of the digital printer, wherein the print density of more than one and less than all print color channels of the digital printer intended for printing the test color is determined in step i).

3. Method The method according to claim 1, wherein in step b) more than one test color is determined and the digital test pattern is provided with at least one single-colored test stripe for each determined test color.

4. The method according to claim 1, wherein the digital test pattern for at least one test color of the specified digital image is provided with at least two single-colored test stripes and preferably the number of single-colored test stripes for the at least one test color of the specified digital image is less than or equal to the number of color channels of the digital printer,
wherein preferably for the at least one test color one single-colored test stripe is defined by the print density from a single print color channel of the digital printer, one single-colored test stripe is defined by the print density of all print color channels of the digital printer, and the optionally remaining single-colored test stripes are defined by the print density of more than one and less than all print color channels of the digital printer.

5. The method according to claim 4, wherein the color channels of the digital printer have a printing sequence, wherein the single-colored test stripe defined by the print density of a single print color channel of the digital printer is defined by the print density of the print color channel to be printed first according to the printing sequence.

6. The method according to claim 5, wherein the single-colored test stripes defined by the print density of more than one and less than all of the print color channels of the digital printer are selected such that
a first of said single-colored test stripes is defined by the print density of the print color channel to be printed first according to the printing sequence and is additionally defined by the print density of the print color channel to be printed subsequently according to the printing sequence; and
optionally each further of said single-colored test stripes is defined by the print density of the respective previous single-colored test stripe and additionally by the print density of the print color channel to be printed subsequently according to the printing sequence.

7. The method according to claim 1, wherein the test colors are selected from the colors occurring most frequently in the specified digital image, wherein optionally a minimum distance in the color space is maintained between a plurality of test colors, and/or the test colors are selected independently of a color frequency in the specified digital image and the largest possible distance between the test colors in the color space is maintained.

8. The method according to claim 1, wherein steps d) to g) are carried out iteratively several times in succession.

9. The method according to claim 1, wherein the optical color measuring device is selected from the group consisting of a color sensor, a colorimeter, a spectrophotometer, a digital camera and a spectral densitometer, wherein the optical color measuring device is preferably based on the same color model as the digital printer.

10. The method according to claim 1, wherein step e) is optionally carried out several times in succession with different settings of the optical color measuring device, in particular under different lighting conditions and/or exposure times.

11. The method according to claim 1, wherein in step g) the correction data are applied to the printer, wherein in particular the correction is carried out by adjusting the print head electronics.

12. The method according to claim 1, wherein in step g) the correction data are applied to the specified digital image, wherein in particular the correction is made by adjusting print dots of the color channel patterns of the specified digital image.

13. The method according to claim 1, wherein the color model of the intended digital image is selected from RGB, CMY and CMYK, wherein the color model is in particular CMYK.

14. A device comprising a data memory, a computing unit, a digital printer for outputting a specified digital image and an optical color measuring device, wherein the device is adapted to carry out the method according to claim 1.

15. The method according to claim 1, wherein color correction is for the printing of decorations, in particular for the printing of decorations with low color diversity, for example for wood and/or stone decorations.
